(19) United States
(12) Patent Application Publication
(10) Pub. No.: US 2025/0209337 A1
(43) Pub. Date: Jun. 26, 2025

(54) AGENT CONTROL THROUGH CULTURAL TRANSMISSION

(71) Applicant: DeepMind Technologies Limited, London (GB)

(72) Inventors: Avishkar Ajay Bhoopchand, London (GB); Adrian Ashley Collister, St Albans (GB); Ashley Deloris Edwards, London (GB); Richard Everett, London (GB); Edward Fauchon Hughes, Hereford (GB); Kory Wallace Mathewson, Montreal (CA); Miruna Pîslar, Paris (FR); Alexander Zacherl, London (GB); Lei Zhang, Toronto (CA)

(21) Appl. No.: 18/843,608

(22) PCT Filed: Mar. 3, 2023
(86) PCT No.: PCT/EP2023/055474

§ 371 Date: Sep. 3, 2024

(30) Foreign Application Priority Data
Mar. 3, 2022 (GB) 2202994.6

(51) Int. Cl. G06N 3/092

(52) U.S. Cl. CPC G06N 3/092

(57) ABSTRACT

Methods, systems, and apparatus, including computer programs encoded on a computer storage medium, for controlling agents. In particular, an agent can be controlled using a policy neural network that has been trained to allow the agent to achieve cultural transmission after training.

### CROSS-REFERENCE TO RELATED APPLICATION

This application claims priority to GB Application No. 2202994.6, filed on Mar. 3, 2022. The disclosure of the prior application is considered part of and is incorporated by reference in the disclosure of this application.

### BACKGROUND

This specification relates to controlling agents using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment.

More specifically, the system trains a policy neural network that is used to control the agent so that, after training, the agent can perform instances of tasks in the environment based on information obtained by “observing” one or more expert agents that are in the environment.

In other words, the system can train the policy neural network so that, after training, the agent achieves cultural transmission without requiring any additional training of the policy neural network. “Cultural transmission” refers to transferring knowledge about how to perform the task from one agent, e.g., an expert agent, to another, e.g., the agent that is being controlled by the policy neural network. The system can perform cultural transmission at test time, by observing the expert agent, rather than just by memorizing the expert agent's behavior seen during training.

For example, after training, the agent can interact in the environment for a sequence of time steps while an expert agent performs an instance of a task. Afterwards, as a consequence of how the policy neural network is trained and without any additional training, the agent can perform the instance of the task that was being performed by the expert agent even when the expert agent is no longer present in the environment or is no longer performing actions that are relevant to performing the instance of the task.

In one aspect, a method for training a policy neural network that is configured to receive a policy input comprising an observation of a state of an environment and to process the policy input to generate a policy output that defines an action to be performed by an agent in response to the observation is described.

The method comprises generating a training trajectory by controlling the agent to perform a task episode in the environment across a plurality of time steps using the policy neural network, wherein the environment includes an expert agent that is attempting to perform an instance of a task, and wherein generating the training trajectory comprises, at each of the plurality of time steps: determining, in accordance with an expert dropout policy for the task episode, whether to cause the expert agent to become unobservable by the agent at the time step; generating an observation characterizing the environment at the time step, comprising: in response to determining to cause the expert agent to become unobservable, generating an observation that does not include any sensor measurements of the expert agent; processing a policy input comprising the observation using the policy neural network to generate a policy output for the observation; and selecting an action to be performed by the agent at the time step using the policy output; and training the policy neural network on the training trajectory.

In some implementations, generating an observation characterizing the environment at the time step comprises: in response to determining not to cause the expert agent to become unobservable, generating an observation that include sensor measurements of the expert agent.

In some implementations, the expert dropout policy for the task episode specifies that the expert agent is observable at all of the plurality of time steps.

In some implementations, the expert dropout policy for the task episode specifies that the expert agent is unobservable at all of the plurality of time steps.

In some implementations, the expert dropout policy for the task episode specifies that the expert agent is only observable at an initial proper subset of the plurality of time steps.

In some implementations, the expert dropout policy for the task episode specifies that, for each of the plurality of time steps, the expert agent is observable with a probability p and unobservable with probability 1−p.

In some implementations, generating the training trajectory comprises, at one or more of the plurality of time steps: receiving a respective reward in response to the agent performing the selected action at the time step; and wherein training the policy neural network on the training trajectory comprises training the policy neural network on the training trajectory using the respective rewards through reinforcement learning.

In some implementations, processing a policy input comprising the observation using the policy neural network to generate a policy output for the observation comprises: processing the policy input using a first subnetwork of the policy neural network to generate a belief representation; and processing the belief representation using a policy head of the policy neural network to generate the policy output.

In some implementations, processing a policy input comprising the observation using the policy neural network to generate a policy output for the observation further comprises: processing the belief representation using an attention head to generate respective predicted positions of one or more other agents in the environment at a particular time step of the plurality of time steps.

In some implementations, the respective prediction positions are ego-centric relative positions relative to the agent.

In some implementations, the particular time step is the time step.

In some implementations, generating the training trajectory comprises, at one or more of the plurality of time steps: receiving a respective ground truth position for each of the one or more other agents; and wherein training the policy neural network on the training trajectory comprises training the policy neural network on the training trajectory to minimize an error between the respective predicted positions and the respective ground truth positions.

In some implementations, the task episode is defined by a respective value for each of a set of task parameters, and wherein generating the training trajectory comprises sampling the respective values for the set of task parameters from a distribution that is parametrized by a set of distribution parameters.

In some implementations, the method further comprises: determining a cultural transmission metric for the agent; and adjusting the set of distribution parameters using the cultural transmission metric for the agent.

In some implementations, determining the cultural transmission metric for the agent comprises: generating a plurality of training trajectories, each with a respective expert dropout policy from a plurality of expert dropout policies; for each training trajectory, obtaining (i) an expert score measuring the performance of the expert agent in performing the instance of the task during the corresponding task episode and (ii) an agent score measuring the performance of the agent in performing the instance of the task during the corresponding task episode; and determining the cultural transmission metric from the expert scores and the agent scores.

In another aspect, a method performed by one or more computers and for training a policy neural network that is configured to receive a policy input comprising an observation of a state of an environment and to process the policy input to generate a policy output that defines an action to be performed by an agent in response to the observation is disclosed.

The method comprises: generating a training trajectory by controlling the agent to perform a task episode in the environment across a sequence of plurality of time steps using the policy neural network, wherein the environment includes an expert agent that is attempting to perform an instance of a task, and wherein generating the training trajectory comprises, at each of the plurality of time steps: obtaining an observation of the state of the environment at the time step; processing a policy input comprising the observation using a first subnetwork of the policy neural network to generate a belief representation; processing the belief representation using a policy head of the policy neural network to generate a policy output for the time step; processing the belief representation using an attention head of the policy neural network to generate respective predicted positions of one or more other agents in the environment at a time step that is at a particular position relative to the time step in the sequence of time steps; and selecting an action to be performed by the agent at the time step using the policy output; and training the policy neural network on the training trajectory, comprising, for one or more of the plurality of time steps: receiving a respective ground truth position for each of the one or more other agents at the time step that is at a particular position relative to the time step in the sequence of time steps; and training the policy neural network on the training trajectory to minimize an error between, for each of the one or more time steps, the respective predicted positions and the respective ground truth positions.

In some implementations, the respective predicted positions are ego-centric relative positions relative to the agent.

In some implementations, the particular position is the same position as the position of the time step.

In some implementations, obtaining the observation comprises: determining, in accordance with an expert dropout policy for the task episode, whether to cause the expert agent to become unobservable by the agent at the time step; generating the observation characterizing the environment at the time step, comprising: in response to determining to cause the expert agent to become unobservable, generating an observation that does not include any sensor measurements of the expert agent.

In some implementations, generating an observation characterizing the environment at the time step comprises: in response to determining not to cause the expert agent to become unobservable, generating an observation that include sensor measurements of the expert agent.

In some implementations, the expert dropout policy for the task episode specifies that the expert agent is observable at all of the plurality of time steps.

In some implementations, the expert dropout policy for the task episode specifies that the expert agent is unobservable at all of the plurality of time steps.

In some implementations, the expert dropout policy for the task episode specifies that the expert agent is only observable at an initial proper subset of the plurality of time steps.

In some implementations, the expert dropout policy for the task episode specifies that, for each of the plurality of time steps, the expert agent is observable with a probability p and unobservable with probability 1−p.

In some implementations, generating the training trajectory comprises, at one or more of the plurality of time steps: receiving a respective reward in response to the agent performing the selected action at the time step; and wherein training the policy neural network on the training trajectory comprises training the policy neural network on the training trajectory using the respective rewards through reinforcement learning.

In some implementations, the task episode is defined by a respective value for each of a set of task parameters, and wherein generating the training trajectory comprises sampling the respective values for the set of task parameters from a distribution that is parametrized by a set of distribution parameters.

In some implementations, the method further comprises determining a cultural transmission metric for the agent; and adjusting the set of distribution parameters using the cultural transmission metric for the agent.

In some implementations, determining the cultural transmission metric for the agent comprises: generating a plurality of training trajectories, each with a respective expert dropout policy from a plurality of expert dropout policies; for each training trajectory, obtaining (i) an expert score measuring the performance of the expert agent in performing the instance of the task during the corresponding task episode and (ii) an agent score measuring the performance of the agent in performing the instance of the task during the corresponding task episode; and determining the cultural transmission metric from the expert scores and the agent scores.

In some implementations, the agent is mechanical agent and the environment is a real-world environment.

In either of the above aspects, the training can be performed by a distributed computing system comprising a plurality of controller nodes and one or more inferrer-learner nodes that each correspond to one or more of the controller nodes, wherein each controller node is coupled to a respective instance of the environment.

In some implementations, each respective inferrer-learner node comprises a respective inferrer node for each corresponding controller node that generates trajectories by providing selected actions to the controller node and obtaining observations from the one or more corresponding controller node and that stores trajectories in a buffer memory, and a learner node that accesses trajectories from the buffer, trains the policy neural network on the accessed trajectories and provides updated parameters of the policy neural network to the inferrer nodes.

In some implementations, the respective inferrer nodes and the learner node are deployed on the same device having one or more hardware accelerators.

In some implementations, the distributed computer system further comprises an orchestrator node that coordinates connectivity between inferrer-learner nodes and controller nodes.

Particular embodiments of the subject matter described in this specification can be implemented so as to realize one or more of the following advantages.

This specification generally describes techniques for training a policy neural network to control an agent that operates in an environment with one or more expert agents.

More specifically, this specification describes techniques for training the policy neural network so that, after training, the agent can perform novel instances of tasks by observing the one or more expert agents in the environment. That is, after training, the agent can observe the expert agent(s) perform some or all of a novel instance of a task and can then effectively perform the task without requiring any additional training. In particular, as a result of the described training, the agent can effectively do this even though the agent observes the environment only through sensor measurements and without receiving any privileged information like other agents' explicit actions or observations. In some implementations the agent can learn new a behavior by observing a single human demonstration, without ever training on human data.

Controlling such agents can be particularly valuable in many real-life tasks that require an agent to perform a variety of tasks that are only first demonstrated to the agent after training has been completed rather than tasks that are fixed in advance.

For example, the training system can employ expert dropout during training episodes to cause the agent to, after training, “remember” what an expert agent does and to later “recall” this information in order to successfully perform novel tasks.

As another example, the training system can employ an attention loss during training that encourages the policy neural network's belief representations to represent information about the relative position of other agents in the environment.

As yet another example, the training system can employ automatic domain randomization guided by a cultural transmission metric to ensure that the agent is trained on a diverse set of tasks while still ensuring that the agent can effectively learn from the current task given the current performance of the agent.

Some existing techniques, e.g., imitation learning and policy distillation, train on expert interactions with the environment. That is, the training is itself a product of cultural transmission but, after training, the agent is expected to perform instances of the task without observing the expert agent. While these methods can be highly effective on individual tasks, the resulting agents are not few-shot learners, the training requires privileged access to datasets of human demonstrations or a target, already-learned policy, and the trained policy neural networks struggle to generalise to held-out tasks. By instead training the policy neural network as described in this specification, an agent controlled using the trained policy neural network is able to generalize to held-out tasks and perform new task instances using only few-shot demonstrations without requiring any of the above-described privileged access.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 shows an example architecture of the policy neural network.

FIG. 3 is a flow diagram of an example process for performing expert dropout.

FIG. 4 is a flow diagram of an example process for training using an attention loss.

FIG. 5 is a flow diagram of an example process for training using automatic domain randomization.

FIG. 6 shows activations of a social neuron within the policy neural network at various episode steps.

FIG. 7 shows activations of a goal neuron within the policy neural network at various episode steps.

Like reference numbers and designations in the various drawings indicate like elements.

### DETAILED DESCRIPTION

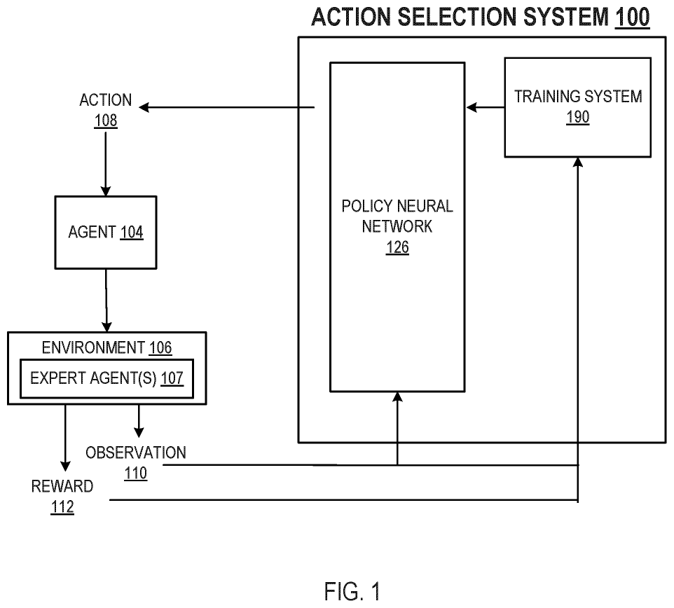

FIG. 1 shows an example action selection system 100. The action selection system 100 is an example of a system implemented as computer programs on one or more computers in one or more locations in which the systems, components, and techniques described below are implemented.

The action selection system 100 controls an agent 104 that is interacting in an environment 106 by selecting actions 108 to be performed by the agent 104 and then causing the agent 104 to perform the actions 108 in order to perform a task.

In particular, at each time step the system 100 receives an observation 110 that characterizes the state of the environment at the time step.

During at least some episodes of interaction, the environment 106 can include one or more expert agents 107.

Expert agents 107 are agents in the environment that are also attempting to perform instances of the task. Generally, expert agents 107 have relatively high likelihoods of successfully completing any given instance of the task.

For example, expert agents 107 may be agents that are controlled by a policy that achieves relatively high rates of success at performing the task, e.g., a hard-coded policy or a policy defined by an already-trained policy neural network. As another example, expert agents 107 can be agents that are controlled by human users. As yet another example, expert agents 107 can be humans that have information needed to perform the task. As yet another example, expert agents 107 can be agents that have access to privileged information that is not available to the agent, e.g., information specifying positions of objects in the environment, information that is measured by one or more sensors that are not accessible to the agent, and so on.

In general the agent 104 only receives information about the interactions of the expert agents 107 through observations 110 that are generated by or provided to the action selection system. For example, when the observations 110 are generated based on measurements of one or more sensors of the agent 104, the agent 104 only receives any information about the expert agents 107 that is included in the sensor measurements. That is, the system 100 does not have access to any privileged information regarding actions taken by expert agents or information observed by expert agents apart from what is available in the observations that are provided to the system 100.

In particular, at each time step, the system 100 receives an observation 110 characterizing the state of the environment 106 at the time step. The observation 110 can be, e.g., generated from sensor measurements generated by one or more sensors of the agent 104, by one or more other sensors located within the environment 106, or both. The one or more sensors can include any of a variety of sensors, e.g., camera sensors, radar sensors, depth sensors, and so on. As one particular example, the one or more sensors can include a LIDAR sensor that repeatedly sweeps the environment in angle, azimuth, or both and measures intensities and positions of reflections of laser light.

The system 100 then processes at least the observation 110 using a policy neural network 126 to select an action 108 to be performed by the agent 104 in response to the observation 110.

In particular, in some implementations, the agent 104 performs a single action 108 in response to each observation 110, e.g., so that a new observation 110 is captured after each action that the agent performs. In these implementations, the system 100 causes the agent to perform the single action, e.g., by providing instructions to the agent 104 that when executed cause the agent to perform the single action, by submitting a control input directly to the appropriate controls of the agent 104, by providing data identifying the action to a control system for the agent 104, or using another appropriate control technique.

In some other implementations, the agent 104 performs a sequence of multiple actions 108 in response to each observation 110, e.g., so that multiple actions are performed by the agent before the next observation 110 is captured. In these implementations, the system 100 generates a sequence of multiple actions 108 that includes a respective action 108 at multiple positions and causes the agent 104 to perform the sequence of actions 108 according to the sequence order, e.g., by performing the action at the first position first, then the action at the second position, and so on. The system 100 can cause the agent 104 to perform a given action as described above.

The policy neural network 126 is a neural network that is configured to receive an input that includes an observation that characterizes the state of the environment and process the input to generate a policy output that defines an action to be performed by the agent in response to the observation. The parameters of the policy neural network will be referred to in this specification as policy network parameters.

In one example, the policy output may include a respective Q-value for each action in a fixed set. The system 100 can process the Q-values (e.g., using a soft-max function) to generate a respective probability value for each action, which can be used to select the action (as described earlier), e.g., by sampling from the probability distributions, or can select the action with the highest Q-value.

The Q value for an action is an estimate of a “return” that would result from the agent performing the action in response to the current observation and thereafter selecting future actions performed by the agent in accordance with current values of the policy neural network parameters.

A return refers to a cumulative measure of “rewards” received by the agent, for example, a time-discounted sum of rewards.

The agent can receive a respective reward 112 at each time step, where the reward is specified by a scalar numerical value and characterizes, e.g., a progress of the agent towards completing an assigned task.

As a particular example, the reward 112 can be a sparse binary reward that is zero unless the task is successfully completed as result of the action being performed, e.g., is only non-zero, e.g., equal to one, if the task is successfully completed as a result of the action performed.

As another particular example, the reward 112 can be a dense reward that measures a progress of the agent towards completing the task as of individual observations received during the episode of attempting to perform the task, e.g., so that non-zero rewards can be and frequently are received before the task is successfully completed.

In another example, the policy output may include a respective numerical probability value for each action in the fixed set. The system can select the action, e.g., by sampling an action in accordance with the probability values for the action indices, or by selecting the action with the highest probability value.

As another example, when the action space is continuous, the policy output can include parameters of a probability distribution over the continuous action space, e.g., means and covariances of a multi-variate Gaussian distribution over the continuous action space.

The system can select the action, e.g., by sampling an action in accordance with the probability values for the action indices, or by selecting the action with the highest probability value.

The input to the policy neural network 126 can include only the observation or can include other information as well as the observations, e.g., the previous action performed by the agent, the previous reward received by the agent, and so on.

The policy neural network 126 can have any appropriate architecture that allows the neural network 126 to map data that is in the format of the policy input to a policy output. Generally, however, the policy neural network 126 has a memory mechanism that allows the policy neural network 126 to incorporate information from previous time steps when generating the policy output at the current time step, e.g. it can include a recurrent neural network.

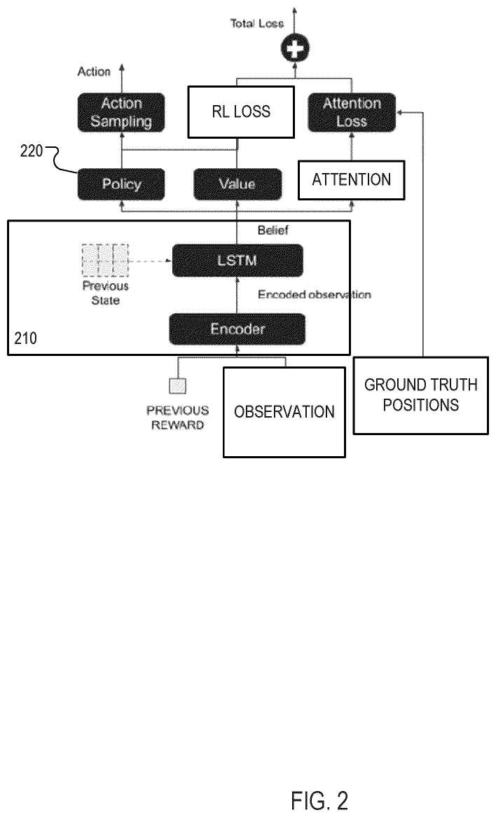

One example of the architecture of the policy neural network 126 is described below with reference to FIG. 2.

Prior to using the policy neural network 126 to control the agent, a training system 190 trains the neural network 126, e.g., to determine trained values of the parameters of the neural network 126, through reinforcement learning.

During training, the training system 190 controls an instance of the agent (or of a simulated version of the agent) using the neural network 126 to perform task episodes.

In other words, to train the policy neural network 126 so that the agent achieves cultural transmission, the system 190 repeatedly generates training trajectories and trains the neural network 126 on the generated training trajectories.

To generate a training trajectory, the system 190 controls an instance of the agent to perform a task episode in the environment across a plurality of time steps using the policy neural network 126.

While the agent is performing the task episode, the environment includes an expert agent that is attempting to perform an instance of the task (and optionally additional expert agents or other, non-expert agents).

To control the agent at a given time step, the system 190 generates an observation characterizing the environment at the time step and processes a policy input that includes the observation using the policy neural network to generate a policy output for the observation, and selects an action to be performed by the agent at the time step using the policy output.

The system 190 then causes the agent to perform the selected action. In some cases, the system 190 selects the action as described above. In other cases, the system 190 applies an exploration policy, e.g., epsilon greedy or some other policy that encourages the agent to explore the environment, to the policy output to select the action.

The system 190 then generates a training trajectory that identifies the observation received at each time step, the action performed at each time step, and additional information, e.g., the reward received at each time step.

The system 190 then trains the policy neural network 126 on the training trajectory, e.g., through reinforcement learning or another appropriate training technique. Generally, the system 190 can use any appropriate training technique to train the policy neural network 126, e.g., an on-policy or off-policy reinforcement learning technique that is appropriate for the type of policy output that the neural network 126 is configured to generate. Examples of reinforcement learning techniques that can be used include temporal difference learning techniques, actor-critic techniques, policy gradient techniques, and relative entropy objective techniques, e.g., Maximum a Posteriori Policy Optimization (MPO), and so on.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

As a result of these task episodes, the system 190 generates training trajectories and uses the training trajectories to train the neural network 126. That is, the system 190 repeatedly generates training trajectories and trains the neural network 126 on the generated training trajectories. For example, the system 190 can store generated trajectories in a replay buffer or other memory and periodically sample trajectories from the buffer and use the sampled trajectories to train the policy neural network 126.

In particular, during the training, the training system 190 makes use of one or more techniques that improve the degree of cultural transmission that is achieved by the agent 106 after the training. For example, to cause the agent to achieve cultural transmission, the system 190 can use “expert dropout” when generating training trajectories for use in training the neural network 126, can employ an “attention loss” during training of the neural network 126 on the training trajectories, or both.

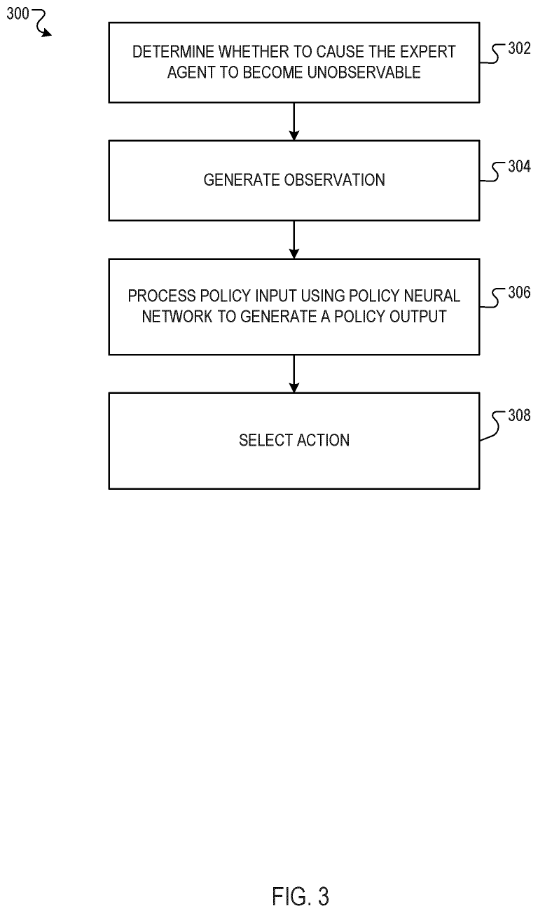

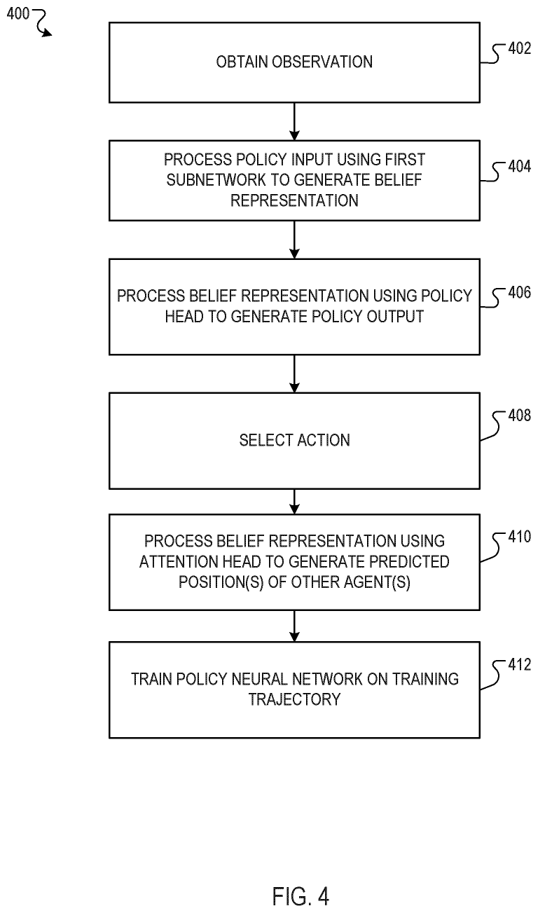

Expert dropout is described in more detail below with reference to FIG. 3. The attention loss is described in more detail below with reference to FIGS. 2 and 4.

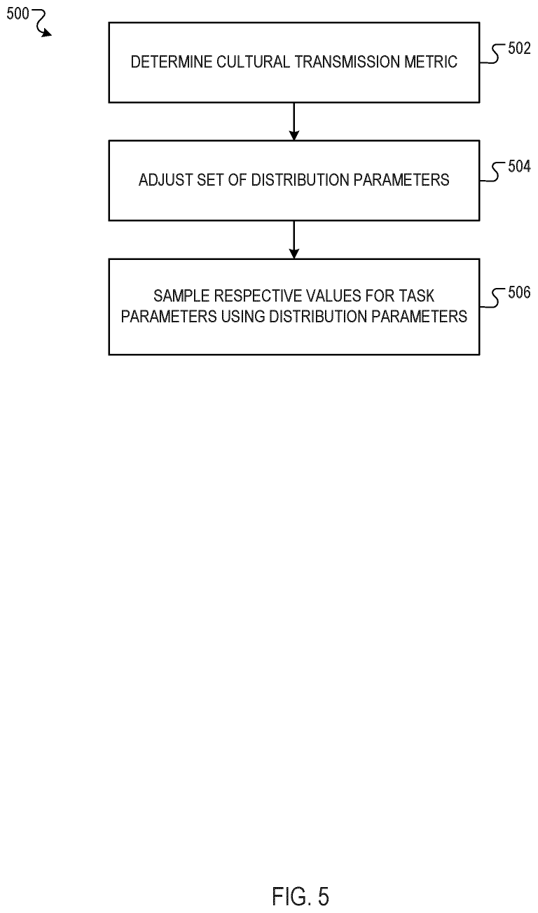

In some implementations, the system can also make use of additional techniques to improve cultural transmission. For example, the system can initialize task episodes using domain randomization based on the current cultural transmission metric achieved by the agent. This is described in more detail below with reference to FIG. 5.

In some cases, the training system 190 distributes the training of the policy neural network 126 across multiple devices.

In other words, the training is performed by a distributed computing system that includes multiple nodes, each of which is deployed on a respective set of one or more computers.

As one example of a distributed architecture, the distributed computing system can include a plurality of controller nodes and one or more inferrer-learner nodes that each correspond to one or more of the controller nodes.

In this example, each controller node is coupled to a respective instance of the environment. For example, each controller node can run a different instance of a computer simulation of a real-world environment. Such an approach can be used, e.g., when the system trains the policy neural network in simulation and then deploys the trained policy neural network for controlling the agent in a real-world environment.

Each inferrer-learner node can include a respective inferrer node for each corresponding controller node, e.g., one inferrer node for each controller node to which the inferer-learner node corresponds.

Each inferrer node generates trajectories by providing selected actions to the corresponding controller node and obtaining observations from the one or more corresponding controller nodes, e.g., that are generated as a result of the controller node causing the selected action to be performed by the, e.g. simulated, agent, in the environment instance to which the controller node is coupled. The inferrer node then stores the trajectories in a buffer memory.

Each inferrer-learner node can also include a learner node that accesses trajectories from the buffer memory, trains the policy neural network on the accessed trajectories and provides updated parameters of the policy neural network to the inferrer nodes. For example, the respective inferrer node(s) and the learner node can be deployed on the same device having one or more hardware accelerators or on two or more devices that each have one or more hardware accelerators.

Optionally, the distributed computer system can also include an orchestrator node that coordinates connectivity between inferrer-learner nodes and controller nodes and that collects statistics used to perform domain randomization, as will be described in more detail below.

In some implementations, the environment is a real-world environment and the agent is a mechanical agent interacting with the real-world environment, e.g. to perform one or more selected actions in the real-world environment. For example, the agent may be a robot interacting with the environment to accomplish a goal, e.g., to locate an object of interest in the environment, to move an object of interest to a specified location in the environment, to physically manipulate an object of interest in the environment in a specified way, or to navigate to a specified destination in the environment; or the agent may be an autonomous or semi-autonomous land, air, or sea vehicle navigating through the environment to a specified destination in the environment.

The actions may be control inputs to control a mechanical agent, e.g. a robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Actions may additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the actions may include actions to control navigation e.g. steering, and movement e.g., braking and/or acceleration of the vehicle.

In some implementations the environment is a simulated environment and the agent is implemented as one or more computer programs interacting with the simulated environment. For example, the environment can be a computer simulation of a real-world environment and the agent can be a simulated mechanical agent navigating through the computer simulation.

For example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. As another example, the simulated environment may be a computer simulation of a real-world environment and the agent may be a simulated robot interacting with the computer simulation.

Generally, when the environment is a simulated environment, the actions may include simulated versions of one or more of the previously described actions or types of actions.

In some cases, the system can be used to control the interactions of the agent with a simulated environment, using observations of the simulated environment, and the system can train the parameters of the policy neural network 126 used to control the agent based on the interactions of the agent with the simulated environment. After the neural network 126 is trained based on the interactions of the agent with a simulated environment, the trained policy neural network can be used to control the interactions of a real-world agent with the real-world environment, e.g., to control the agent that was being simulated in the simulated environment. That is, the simulation may be a simulation of the real-world environment, and the observations and actions of the agent in the simulated environment may relate to observations of, and actions to be performed in, the real-world environment. Training the deep neural network based on interactions of an agent with a simulated environment (e.g., instead of a real-world environment) can avoid wear-and-tear on the agent and can reduce the likelihood that, by performing poorly chosen actions, the agent can damage itself or aspects of its environment. In some cases, the system may be partly trained using a simulation as described above and then further trained in the real-world environment.

As another example, the environment can be a video game and the agent can be an agent within the video game that interacts with one or more other agents, e.g., agents controlled by one or more human users.

As yet another example, the environment can be an augmented reality or virtual reality representation of a real-world environment, and the agent can be an entity in the representation that interacts with one or more other agents, e.g., agents controlled by one or more human users. In the case of an augmented reality environment, the observation may comprise image data characterizing the real-world environment, including for example, an object of interest in the environment. The agent may be a software agent configured to control an electromechanical device in the real-world environment to perform one or more selected actions in the real-world environment, such as manipulating, moving, fixing and/or reconfiguring the object. The augmented reality environment may be displayed to a user, e.g. through a head-mounted display or a heads-up display.

As yet another example, the environment can be a computing environment, e.g., one or more computing devices optionally connected by a wired or wireless network, and the agent can be a software agent executing within the computing environment to interact with a user. For example, the agent can be digital assistant software that carries out tasks specified by a user within the computing environment by performing actions that control one or more of the computing devices, e.g. based on observations relating to a state of the user's environment e.g. obtained from a camera or from a natural language interface.

FIG. 2 shows an example architecture of the policy neural network 126.

In the example of FIG. 2, the policy neural network 126 includes a first subnetwork 210 that processes an input observation to generate a belief representation and a policy head 220 that processes the belief representation to generate the policy output.

The belief representation is an internal representation of the state of the environment at the time step and, optionally, of previous states of the environment at previous time steps. Generally, the belief representation is a tensor, e.g., a vector, matrix, or feature map, of numerical values that has a fixed dimensionality.

For example, in the example of FIG. 2, the first subnetwork 210 includes an encoder neural network that processes the observation and the previous reward to generate an encoded representation. The encoder neural network can have any appropriate architecture that allows the neural network encode observations that are received as input. For example, the encoder neural network can be a convolutional neural network, a Transformer neural network, a multi-layer perceptron (MLP), and so on.

The first subnetwork 210 can also include a recurrent neural network, e.g., a long-short term memory (LSTM) neural network, that processes the encoded representation and a previous internal state of the recurrent neural network to update the previous internal state and to generate the belief representation. Thus, because the first subnetwork includes a recurrence mechanism, e.g., because of the use of the internal state that acts as a “memory” of previous states, the belief representation includes information about the current state of the environment and previous states of the environments.

A “head,” as used in this specification, is a collection of one or more neural network layers. Thus, the policy head 220 can have any appropriate architecture that allows the head to map the belief representation to a policy output. For example, the policy head can be a multi-layer perceptron (MLP) or a different type of feedforward neural network.

In the example of FIG. 2, during training, the system 190 also makes use of one or more auxiliary components to improve the effectiveness of the training process. In particular, during training the policy neural network 126 can include one or more auxiliary heads that are used to improve the quality of the belief representations generated by the first subnetwork. After training, the policy neural network 126 can be used without the auxiliary heads, e.g., can include only the first subnetwork and the policy head.

For example, when the training system 190 employs a reinforcement learning technique that requires a value estimate, the training system 190 can use a value head that processes the belief representation to generate the value estimate. One example of such a reinforcement learning technique is Maximum a Posteriori Policy Optimization (MPO).

As another example, when the training system 190 uses the attention loss during training, the training system 190 can use an attention head. At any given time step, the attention head processes an input that includes the belief representation for the time step to generate respective predicted positions of one or more other agents in the environment at a particular time step of the plurality of time steps. In some cases, the input to the attention head can include, in addition to the belief representation, additional information, e.g., the current action performed by the agent as of the given time step.

The respective predicted position of a given other agent can be, e.g., an ego-centric relative position relative to the agent. That is, the auxiliary head can predict, for each other agent, the position of the other agent in an ego-centric coordinate system centered at the agent.

For example, the auxiliary head can be, e.g., a multi-layer perceptron (MLP).

The system also obtains, for one or more of the time steps in the trajectory, a ground truth position of each other agent in the environment at the time step. For example, the system can obtain sensor measurements from one or more sensors positioned in the environment remotely from the agent or can obtain the ground truth positions from the simulator state when training is performed in simulation.

As one example, when the agent is training in simulation, the system can obtain measurements from an AVATAR sensor which outputs the respective 3-dimensional relative distance of the one or more nearest other agents, e.g., in Cartesian coordinates, in the frame of reference of the agent.

When the agent is training in the real-world, the agent can use one or more sensors, e.g., a depth sensor, a radar sensor, a lidar sensor, and so on, positioned on the body of the agent or remotely in the environment to sense the surroundings and then use a localization system to generate the ground truth positions from the sensor measurements.

Then, when training on the generated trajectory, the system trains the neural network to minimize an attention loss that measures, for each of the one or more time steps, the error between the respective predicted positions and the respective ground truth positions.

For example, the loss can measure, for each other agent, the distance, e.g., the 11 or 12 distance, between the predicted position of the agent and the ground truth position of the agent. Thus, employing this attention loss assists with cultural transmission because it requires the agent to encode information about the positions of other agents in the belief representation that is then used to select the action.

As indicated above, the predicted position is a prediction of the position of the other agent at a particular time step of the plurality of time steps, e.g., at a particular time step that is at a particular position relative to the given time step in the sequence of time steps that occur during the training episode and that are represented in the training trajectory.

For example, the particular time step can be the same as the current time step, e.g., so that the particular position is the same as the position of the current time step and the auxiliary head predicts the current position of the other agent at the current time step.

As another example, the particular time step can be a time step a threshold number of positions before the current position of the current time step, e.g., so that the auxiliary head predicts a previous position of the other agent at a preceding time step. This can encourage the belief representation to include information that accurately reflects previous states of the environment.

As another example, the particular time step can be a time step that is a threshold number of positions after the current position of the current time step, e.g., so that the auxiliary head predicts a future position of the other agent at a future time step. This can encourage the belief representation to include information that can accurately model the future state of the environment.

As shown in the example of FIG. 2, the loss is a combination of, e.g., a weighted sum of, a reinforcement learning loss that is computed using received rewards, the policy output, and the value estimates and the attention loss. For example, the loss can be a weighted sum of the reinforcement learning (RL) loss and the attention loss, with the weight being a hyperparameter of the training process that is determined using, e.g., a hyperparameter sweep, or that is received as input by the system.

FIG. 3 is a flow diagram of an example process 300 for generating a training trajectory using expert dropout. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system can perform the process 300 at each of multiple time steps during a task episode in order to control the agent and to generate a training trajectory.

More specifically, as described above, to generate a training trajectory, the system controls the agent to perform a task episode in the environment across a plurality of time steps using the policy neural network.

While the agent is performing the task episode, the environment includes an expert agent that is attempting to perform an instance of the task (and optionally additional expert agents or other, non-expert agents).

When expert dropout is being employed, at each time step during the task episode, the system determines, in accordance with an expert dropout policy for the task episode, whether to cause the expert agent to become unobservable by the agent at the time step (step 302).

In some cases, the system uses the same expert dropout policy for all task episodes. In other cases, the system uses different expert dropout policies for different task episodes.

For example, the expert dropout policy for the task episode can specify that the expert agent is observable at all of the plurality of time steps.

As another example, the expert dropout policy for the task episode can specify that the expert agent is unobservable at all of the plurality of time steps.

As another example, the expert dropout policy for the task episode can specify that the expert agent is observable at some but not all of the plurality of time steps. For example, the expert dropout policy for the task episode can specify that the expert agent is only observable at an initial proper subset (e.g. some but not all) of the plurality of time steps, e.g., the first half of the time steps or for a different initial fraction of the time steps.

As one example, the system can switch between these three expert dropout policies during training, e.g., by sampling one of the three policies at the beginning of each task episode from a specified distribution over the dropout policies. Optionally, the system can adjust the distribution as training proceeds, e.g., to assign more weight to expert dropout policies at which the expert is unobservable for at least some of the time steps. For example, the system can adjust the distribution according to a fixed schedule or using domain randomization as described below.

As another example, the expert dropout policy for the task episode can specify that, for each of the plurality of time steps, the expert agent is observable with a probability p and unobservable with probability 1−p. In some of these examples, the system can adjust the value of p throughout training, e.g., to form a training curriculum. For example, the system can adjust the value of p according to a fixed schedule or using domain randomization as described below.

The system then generates an observation for the time step (step 304).

If the system determines to cause the expert agent to become unobservable, the system generates an observation that does not include any sensor measurements of the expert agent even when the agent is present in the environment at the time step and is within range of the sensor(s) that are used to generate the observation.

For example, when the agent is being trained in the real-world, the system can modify the sensor measurements generated at the time step when generating the observation so that no measurements of the expert are included. For example, the system can mask out or in-fill a portion of an image or point cloud that measures the expert agent. That is, the system can remove points representing the expert agent from the point cloud or can in-fill the portion of the image that depicts the expert agent so that the image appears to be of a scene that does not include the expert agent.

As another example, when the agent is being trained in simulation, the system can modify the state of the computer simulation so that the expert agent is excluded, and then generate the observation from the modified state. For example, the system can modify the state to exclude the expert agents to generate a modified state and then generate the observations by generating one or more synthetic (or simulated) sensor measurements that measure the modified state.

If the system determines not to cause the expert agent to become unobservable, the system generates an observation that includes sensor measurements of the expert agent (if the expert agent is within range of the sensor(s) that are used to generate the observation at the time step). That is, the system generates the observation from sensor measurements using conventional techniques.

Thus, employing this expert dropout assists with cultural transmission because it requires the agent to be able to perform high quality actions even when the expert agent is not present in the environment.

The system processes a policy input that includes the observation using the policy neural network to generate a policy output for the observation (step 306) and selects an action to be performed by the agent at the time step using the policy output (step 308).

In some cases, the system selects the action as described above. In other cases, the system applies an exploration policy, e.g., epsilon greedy or some other policy that encourages the agent to explore the environment, to the policy output to select the action.

The system then causes the agent to perform the selected action.

Generally, for at least one of the time steps, the system receives a respective reward in response to the agent performing the selected action at the time step and includes the reward in the training trajectory.

When later training the policy neural network on the training trajectory, the system trains the policy neural network on the training trajectory using the respective rewards through reinforcement learning.

As described above, in addition or instead of using expert dropout, the system can also make use of an attention loss that can, e.g., serve as an auxiliary loss to the reinforcement learning loss that is used to train the policy neural network.

FIG. 4 is a flow diagram of an example process 400 for generating a training trajectory and training the neural network using an attention loss. For convenience, the process 400 will be described as being performed by a system of one or more computers located in one or more locations. For example, an action selection system, e.g., the action selection system 100 of FIG. 1, appropriately programmed in accordance with this specification, can perform the process 400.

When the attention loss is employed, to generate a trajectory or when training on a trajectory accessed from the replay memory, at each time step, the system obtains an observation of the state of the environment at the time step (step 402). For example, the observation can have been generated using expert dropout as described above or using conventional techniques when the system does not employ expert dropout.

The system processes a policy input that includes the observation using a first subnetwork of the policy neural network to generate a belief representation (step 404). As described above, the belief representation is an internal representation of the state of the environment at the time step and, optionally, of previous states of the environment at previous time steps. Generally, the belief representation is a tensor, e.g., a vector, matrix, or feature map, of numerical values that has a fixed dimensionality.

The system processes the belief representation using a policy head of the policy neural network to generate the policy output for the time step (step 406).

The system also processes the belief representation using an attention head of the policy neural network to generate respective predicted positions of one or more other agents in the environment at a particular time step that is at a particular position relative to the time step in the sequence of time steps (step 408).

As described above, the particular time step can be the same as the current time step, e.g., so that the particular position is the same as the position of the current time step, can be a time step a threshold number of positions before the current position of the current time step, or can be a time step that is a threshold number of positions after the current position of the current time step.

Then, when training on the generated trajectory, for one or more of the plurality of time steps, the system receives a respective ground truth position for each of the one or more other agents at the time step that is at a particular position relative to the time step in the sequence of time steps (step 410). For example, the system can receive the ground truth positions when the trajectory is generated and store the ground truth positions as part of the trajectory or otherwise in association with the trajectory in the replay memory.

The system then trains the policy neural network on the training trajectory to minimize an error between, for each of the one or more time steps, the respective predicted positions and the respective ground truth positions (step 412).

Thus, employing this attention loss assists with cultural transmission because it requires the agent to encode information about the positions of other agents in the belief representation that is then used to select the action. Thus, the agent learns to observe the other agents in the environment as part of performing the task and can therefore leverage these “observations” of other agents to better perform the task.

FIG. 5 is a flow diagram of an example process 500 for training using domain randomization. For convenience, the process 500 will be described as being performed by a system of one or more computers located in one or more locations. For example, a training system, e.g., the training system 190 of FIG. 1, appropriately programmed in accordance with this specification, can perform the process 500.

The system can repeatedly perform the process 500 during the training of the policy neural network to modify how task episodes are generated.

When making use of domain randomization, each task episode is defined by a respective value for each of a set of task parameters.

That is, the task parameters collectively define certain configurable settings of the task episodes. Thus one or more aspects of a task to be performed in a task episode can be defined by the task parameters.

For example, the task parameters can specify one or more of: aspects of the environment to be interacted with during the task episode, aspects of the task to be performed during the task episode, or aspects of the other agents present in the environment during the task episode.

As another example, the task parameters can define which expert dropout policy is used during the task episode.

To instantiate a task episode, the system can determine whether criteria are satisfied for sampling new task parameters values and, if so, the system can sample respective values for the set of task parameters from a distribution that is parametrized by a set of distribution parameters and then instantiates a task episode that is specified by the sampled values of the task parameters.

As a particular example, when there are d task parameters, each set of task parameters A can be drawn from a distribution P_{ϕ}(Λ) over the (d−1)-dimensional standard simplex, parameterised by a vector ϕ. For example, the distribution can be a product of uniform distributions with 2d parameters and joint cumulative density function:

$${P}_{ϕ} ( λ ) = {\prod }_{i = 1}^{d} \frac{1}{{ϕ}_{i}^{L} - {ϕ}_{i}^{H}} ,$$

defined over the standard simplex given by {λ: λᵢ∈[ϕᵢ^{L}, ϕᵢ^{H}] for i∈{1, . . . , d}, λ∈ [symbol] }. The task parameters, λ, drawn from the distribution defined by vector ϕ, can define a task to be performed in a task episode.

Optionally, when sampling a parameter λ, with probability p_{b} a task parameter λ_{b} is chosen uniformly at random to be fixed to one of its ‘boundaries’ [ϕ_{b}^{L}, ϕ_{b}^{H}] while, with probability 1−p_{b}, the parameter is sampled from the distribution above.

More specifically, at each iteration of the process 500, the system determines a cultural transmission metric (CT metric) for the agent (step 502). Generally, the CT metric measures the degree of cultural transmission being exhibited by an agent controlled by the current policy neural network as of the current point in training. For example the CT metric can measure a degree to which the agent benefits, when performing a task, from observing the expert agent attempt to perform the task.

As an example, to determine the CT metric, the system can generate a plurality of training trajectories, each with a respective expert dropout policy from a plurality of expert dropout policies and each being generated by performing a task episode defined by a respective set of task parameters. For example, the system can generate the training trajectories using the current values of the policy network parameters and each trajectory can correspond to a held-out instance of the task that has not been used to generate the trajectories in the replay memory.

For each training trajectory, the system obtains (i) an expert score measuring the performance of an expert agent in performing the instance of the task during the corresponding task episode and (ii) an agent score measuring the performance of the agent in performing the instance of the task during the corresponding task episode. For example, the expert score can be the discounted or undiscounted return received by the expert while the agent score can be the discounted or undiscounted return received by the agent.

The system then determines the CT metric from the expert scores and the agent scores. That is, in this example the CT metric measures the relative performance of the agent to the expert under various different expert dropout policies.

As a particular example, the CT metric can satisfy:

$$\frac{\frac{1}{2} ( {A}_{full} - {A}_{solo} )}{E} + \frac{\frac{1}{2} ( {A}_{half} - {A}_{solo} )}{E} ,$$

where E is the expert score for a training trajectory for a given task episode, A_{full} is the agent score for the given task episode when the expert dropout policy specifies that the expert is not dropped out for any time steps, A_{half} is the agent score for the given task episode when the expert dropout policy specifies that the expert is not dropped out for only the first half of the time steps, and Aₛₒₗₒ is the agent score for the given task episode when the expert dropout policy specifies that the expert is dropped out for all time steps.

The system then adjusts the set of distribution parameters (step 504) using the CT metric. For example, the system can expand the simplex boundaries ϕᵢ^{L} or ϕᵢ^{H} if an overall CT metric exceeds a first threshold and contract the simplex boundaries ϕᵢ^{L} or ϕᵢ^{H} if an overall CT metric drops below a lower threshold. This maintains the task distribution in the appropriate zone for learning cultural transmission, e.g., ensures a diverse set of tasks while ensuring that the agent can effectively learn from the resulting trajectories.

More specifically, for each parameter λ_{b} one or both of its ‘boundaries’ [ϕ_{b}^{L}, ϕ_{b}^{H}] are updated by domain randomization.

When the lower boundary for a given parameter λᵢ is updated using domain randomization, the system can update the boundary as follows:

ϕᵢ^{L}={ϕᵢ^{L}−Δᵢ if c(i, L)>th_{H}, ϕᵢ^{L}+Δᵢ if c(i, L)<th_{H}, ϕᵢ^{L} otherwise} and, similarly, when the higher boundary for a given parameter λᵢ is updated using domain randomization, the system can update the boundary as follows:

$${ϕ}_{i}^{H} = \{ {ϕ}_{i}^{H} + {Δ}_{i} if c ( i , H ) > {th}_{H} , {ϕ}_{i}^{H} - {Δ}_{i} if c ( i , H ) < {th}_{H} , {ϕ}_{i}^{H} otherwise \} ,$$

where th_{H} and th_{L} are predetermined threshold values, λᵢ is a fixed step size, c(i, L) is the average CT metric computed when the parameter λᵢ is set to ϕᵢ^{L}, and c(i, H) is the average CT metric computed when the parameter λᵢ is set to ϕᵢ^{H}.

That is, in this example, when determining whether to update a given boundary value for a given parameter, the system uses the average of the CT metrics computed for trajectories generated while the given parameter was set to the boundary value.

The system then samples respective values for the set of task parameters from a distribution that is parametrized by the adjusted set of distribution parameters (step 506) and uses the sampled values to instantiate a task episode. The training processes described herein can be performed repeatedly, using task episodes determined by sampling values for the set of task parameters from the distribution.

To increase efficiency, the system can update the CT metric and re-sample the task parameter values at intervals during the training rather than after every task episode, e.g., after a certain number of trajectories have been generated or a certain amount of wall clock time has elapsed.

In some cases, as a result of the above-described training, some of the neurons in the policy neural network exhibit certain properties that are useful in controlling the agent.

For example, one or more of the neurons in the policy neural network, e.g., in the last layer of the first subnetwork that generates the belief representations, can be social neurons. A social neuron is a neuron that, at any given time step, encapsulates the notion of agency. In particular, the social neuron can, through its activation, encode the presence or absence of an expert agent in the environment at the given time step. That is, the activation value of the social neuron at a given time step is indicative of whether an expert agent is present or absent in the environment at the given time step. An activation value can be said to be indicate the absence of the agent when the activation has a positive sign and a magnitude more than a threshold value, e.g., 0.05, 0.10, or 0.15, above zero and can be said to indicate the presence of the agent when the activation has a negative sign (or vice versa).

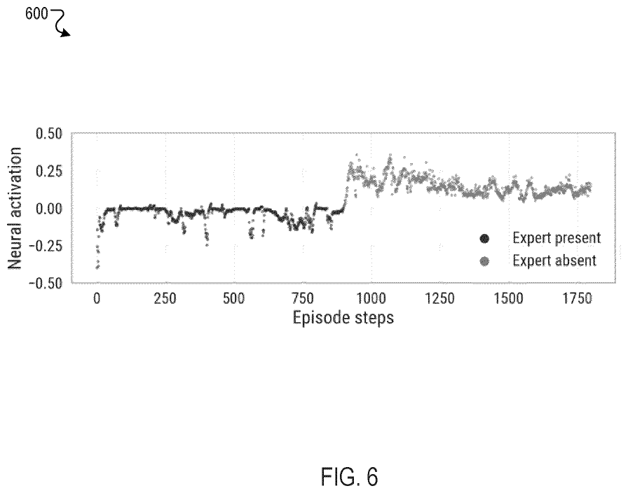

FIG. 6 shows activations of a social neuron within the policy neural network at various episode steps. More specifically, FIG. 6 includes a plot 600 with episode steps on the horizontal axis and activation values of the social neuron on the vertical axis. In the example of FIG. 6, an expert agent was present in the environment for the first half of the episode, but not for the second half. As can be seen from FIG. 6, the social neuron consistently generated activation values with positive signs and above the thresholds when the agent was absent while generating zero or negative values when the agent was present.

As another example, one or more of the neurons in the policy neural network, e.g., in the last layer of the first subnetwork that generates the belief representations, can be goal neurons. A goal neuron is a neuron that, at any given time step, captures a periodicity of a task. In particular, the goal neuron can, through its activation, indicate the entry of the agent into a goal sphere, where a goal sphere is a vicinity (in the state space of the environment) of a rewarding state, i.e., a state where the agent receives a positive reward that may indicate that it has reached a goal that is part performing the task. That is, the activation value of the goal neuron at a given time step is indicative of whether the agent has entered the goal sphere. As a particular example, the goal neuron can “fire” when the agent enters the goal sphere and continues firing while the agent is within the goal sphere and does not fire when the agent is not in the goal sphere. An activation value can be said to be “firing” when its value is above a threshold, e.g., 0.25, 0.3, or 0.5.

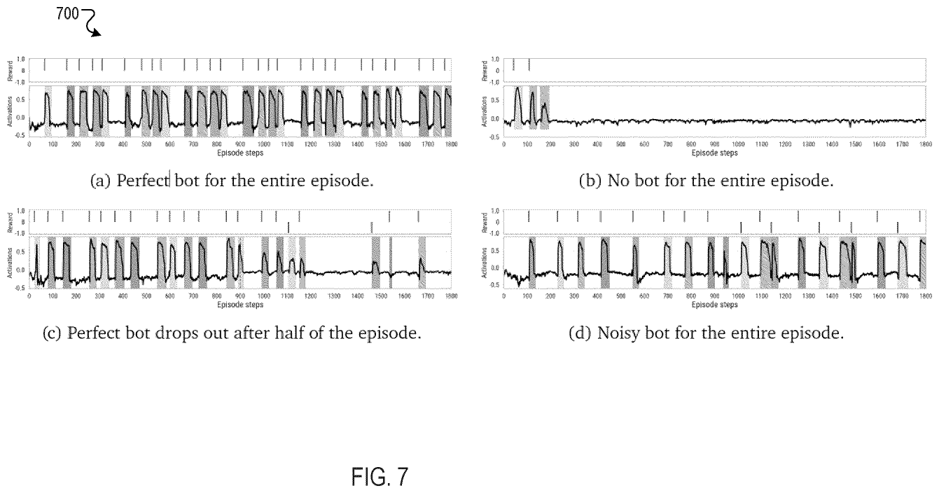

FIG. 7 shows activations of a goal neuron within the policy neural network at various episode steps. More specifically, FIG. 7 includes plots 700 a), b), c), and d) with episode steps on the horizontal axis and activation values of the goal neuron on the vertical axis

In particular, FIG. 7 shows the activations of the goal neuron as a dark line under four circumstances: a) a perfect bot (an expert agent that can perform the task perfectly) is in the episode at all time steps b) no expert bot is in the episode c) perfect bot drops out after half the episode and d) a noisy bot (an agent that is not an expert and only occasionally performs the task accurately) is in the episode at all time steps. Under all of these conditions, FIG. 6 shows that the goal neuron consistently fires when the agent is within a goal sphere (shaded time steps that are within the vicinity of states where a positive reward was received) and does not fire when the agent is not, no matter what the pattern is of entering goal spheres during the task episode.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more computers and for training a policy neural network that is configured to receive a policy input comprising an observation of a state of an environment and to process the policy input to generate a policy output that defines an action to be performed by an agent in response to the observation, the method comprising:
generating a training trajectory by controlling the agent to perform a task episode in the environment across a plurality of time steps using the policy neural network, wherein the environment includes an expert agent that is attempting to perform an instance of a task, and wherein generating the training trajectory comprises, at each of the plurality of time steps:
determining, in accordance with an expert dropout policy for the task episode, whether to cause the expert agent to become unobservable by the agent at the time step;
generating an observation characterizing the environment at the time step, comprising:
in response to determining to cause the expert agent to become unobservable, generating an observation that does not include any sensor measurements of the expert agent;
processing a policy input comprising the observation using the policy neural network to generate a policy output for the observation; and
selecting an action to be performed by the agent at the time step using the policy output; and
training the policy neural network on the training trajectory.

2. The method of claim 1, wherein generating an observation characterizing the environment at the time step comprises:
in response to determining not to cause the expert agent to become unobservable, generating an observation that includes sensor measurements of the expert agent.

3. The method of claim 1, wherein the expert dropout policy for the task episode specifies that the expert agent is observable at all of the plurality of time steps.

4. The method of claim 1, wherein the expert dropout policy for the task episode specifies that the expert agent is unobservable at all of the plurality of time steps.

5. The method of claim 1, wherein the expert dropout policy for the task episode specifies that the expert agent is only observable at an initial proper subset of the plurality of time steps.

6. The method of claim 1, wherein the expert dropout policy for the task episode specifies that, for each of the plurality of time steps, the expert agent is observable with a probability p and unobservable with probability 1−p.

7. The method of claim 1, wherein generating the training trajectory comprises, at one or more of the plurality of time steps:
receiving a respective reward in response to the agent performing the selected action at the time step; and
wherein training the policy neural network on the training trajectory comprises training the policy neural network on the training trajectory using the respective rewards through reinforcement learning.

8. The method of claim 1, wherein processing a policy input comprising the observation using the policy neural network to generate a policy output for the observation comprises:
processing the policy input using a first subnetwork of the policy neural network to generate a belief representation; and
processing the belief representation using a policy head of the policy neural network to generate the policy output.

9. The method of claim 8, wherein processing a policy input comprising the observation using the policy neural network to generate a policy output for the observation further comprises:
processing the belief representation using an attention head to generate respective predicted positions of one or more other agents in the environment at a particular time step of the plurality of time steps.

10. The method of claim 9, wherein the respective prediction positions are ego-centric relative positions relative to the agent.

11. The method of claim 9, wherein the particular time step is the time step.

12. The method of claim 9, wherein generating the training trajectory comprises, at one or more of the plurality of time steps:
receiving a respective ground truth position for each of the one or more other agents; and
wherein training the policy neural network on the training trajectory comprises training the policy neural network on the training trajectory to minimize an error between the respective predicted positions and the respective ground truth positions.

13. The method of any claim 1, wherein the task episode is defined by a respective value for each of a set of task parameters, and wherein generating the training trajectory comprises sampling the respective values for the set of task parameters from a distribution that is parametrized by a set of distribution parameters.

14. The method of claim 13, further comprising:
determining a cultural transmission metric for the agent; and
adjusting the set of distribution parameters using the cultural transmission metric for the agent.

15. The method of claim 14, wherein determining the cultural transmission metric for the agent comprises:
generating a plurality of training trajectories, each with a respective expert dropout policy from a plurality of expert dropout policies;
for each training trajectory, obtaining (i) an expert score measuring the performance of the expert agent in performing the instance of the task during the corresponding task episode and (ii) an agent score measuring the performance of the agent in performing the instance of the task during the corresponding task episode; and
determining the cultural transmission metric from the expert scores and the agent scores.

16. A method performed by one or more computers and for training a policy neural network that is configured to receive a policy input comprising an observation of a state of an environment and to process the policy input to generate a policy output that defines an action to be performed by an agent in response to the observation, the method comprising:
generating a training trajectory by controlling the agent to perform a task episode in the environment across a sequence of plurality of time steps using the policy neural network, wherein the environment includes an expert agent that is attempting to perform an instance of a task, and wherein generating the training trajectory comprises, at each of the plurality of time steps:
obtaining an observation of the state of the environment at the time step;
processing a policy input comprising the observation using a first subnetwork of the policy neural network to generate a belief representation;
processing the belief representation using a policy head of the policy neural network to generate a policy output for the time step;
processing the belief representation using an attention head of the policy neural network to generate respective predicted positions of one or more other agents in the environment at a time step that is at a particular position relative to the time step in the sequence of time steps; and
selecting an action to be performed by the agent at the time step using the policy output; and
training the policy neural network on the training trajectory, comprising, for one or more of the plurality of time steps:
receiving a respective ground truth position for each of the one or more other agents at the time step that is at a particular position relative to the time step in the sequence of time steps; and
training the policy neural network on the training trajectory to minimize an error between, for each of the one or more time steps, the respective predicted positions and the respective ground truth positions.

17. The method of claim 16, wherein the respective predicted positions are ego-centric relative positions relative to the agent.

18. The method of claim 16, wherein the particular position is the same position as the position of the time step.

19. The method of claim 16, wherein obtaining the observation comprises:
determining, in accordance with an expert dropout policy for the task episode, whether to cause the expert agent to become unobservable by the agent at the time step;
generating the observation characterizing the environment at the time step, comprising:
in response to determining to cause the expert agent to become unobservable, generating an observation that does not include any sensor measurements of the expert agent.

20. The method of claim 19, wherein generating an observation characterizing the environment at the time step comprises:
in response to determining not to cause the expert agent to become unobservable, generating an observation that include sensor measurements of the expert agent.

21. The method of claim 19, wherein the expert dropout policy for the task episode specifies that the expert agent is observable at all of the plurality of time steps.

22. The method of claim 19, wherein the expert dropout policy for the task episode specifies that the expert agent is unobservable at all of the plurality of time steps.

23. The method of claim 19, wherein the expert dropout policy for the task episode specifies that the expert agent is only observable at an initial proper subset of the plurality of time steps.

24. The method of claim 19, wherein the expert dropout policy for the task episode specifies that, for each of the plurality of time steps, the expert agent is observable with a probability p and unobservable with probability 1−p.

25. The method of claim 16, wherein generating the training trajectory comprises, at one or more of the plurality of time steps:
receiving a respective reward in response to the agent performing the selected action at the time step; and
wherein training the policy neural network on the training trajectory comprises training the policy neural network on the training trajectory using the respective rewards through reinforcement learning.

26. The method of claim 16, wherein the task episode is defined by a respective value for each of a set of task parameters, and wherein generating the training trajectory comprises sampling the respective values for the set of task parameters from a distribution that is parametrized by a set of distribution parameters.

27. The method of claim 26, further comprising:
determining a cultural transmission metric for the agent; and
adjusting the set of distribution parameters using the cultural transmission metric for the agent.

28. The method of claim 27, wherein determining the cultural transmission metric for the agent comprises:
generating a plurality of training trajectories, each with a respective expert dropout policy from a plurality of expert dropout policies;
for each training trajectory, obtaining (i) an expert score measuring the performance of the expert agent in performing the instance of the task during the corresponding task episode and (ii) an agent score measuring the performance of the agent in performing the instance of the task during the corresponding task episode; and
determining the cultural transmission metric from the expert scores and the agent scores.

29-40. (canceled)

41. A system comprising:
one or more computers; and
one or more storage devices communicatively coupled to the one or more computers, wherein the one or more storage devices store instructions that, when executed by the one or more computers, cause the one or more computers to perform
operations for training a policy neural network that is configured to receive a policy input comprising an observation of a state of an environment and to process the policy input to generate a policy output that defines an action to be performed by an agent in response to the observation, the operations comprising:
generating a training trajectory by controlling the agent to perform a task episode in the environment across a plurality of time steps using the policy neural network, wherein the environment includes an expert agent that is attempting to perform an instance of a task, and wherein generating the training trajectory comprises, at each of the plurality of time steps:
determining, in accordance with an expert dropout policy for the task episode, whether to cause the expert agent to become unobservable by the agent at the time step;
generating an observation characterizing the environment at the time step, comprising:
in response to determining to cause the expert agent to become unobservable, generating an observation that does not include any sensor measurements of the expert agent;
processing a policy input comprising the observation using the policy neural network to generate a policy output for the observation; and
selecting an action to be performed by the agent at the time step using the policy output; and
training the policy neural network on the training trajectory.

42. (canceled)
